(19) United States
(12) Patent Application Publication
(10) Pub. No.: US 2025/0369755 A1
(43) Pub. Date: Dec. 4, 2025

(54) Directional Indication Feature for a Level

(71) Applicant: Hultafors Group North America, Inc., Mequon, WI (US)

(72) Inventor: Nicholas C. Ackerman, West Allis, WI (US)

(21) Appl. No.: 19/223,466

(22) Filed: May 30, 2025

Related U.S. Application Data
(60) Provisional application No. 63/655,798, filed on Jun. 4, 2024.

(51) Int. Cl. G01C 9/32

(52) U.S. Cl. CPC G01C 9/32

(57) ABSTRACT

A level that includes a frame, vials, and an illumination arrangement that selectively illuminates the one or more vials. A directional indication arrangement utilizes the illumination arrangement to inform a user as to how the level should be positioned to achieve a desired orientation. The directional indication arrangement includes direction indicating indicia on the frame, such as arrows which, in conjunction with the illumination arrangement operating in the vicinity of the arrows, informs the user how the level should be positioned to achieve the desired orientation

### CROSS-REFERENCE TO RELATED APPLICATIONS

This patent application claims the benefit of U.S. provisional patent application Ser. No. 63/655,798 filed Jun. 4, 2024, the entire contents of which are hereby incorporated by reference.

### BACKGROUND AND SUMMARY

This application relates to construction and layout tools, and more particularly to a level such as is used in determining the orientation of a surface relative to level, plumb or other predetermined angle.

A level is typically employed to ascertain the position of a surface relative to a predetermined orientation, such as level, plumb, 45 degrees, etc. In a typical application, the user will visually observe the position of a bubble contained within a bubble vial incorporated in the level in order to ascertain the how closely the level is positioned relative to the desired orientation. When the level is not in the desired orientation, it is often necessary for the user to observe the bubble as the position of the level is altered first in one direction and then in the other direction to determine the direction in which the level should be moved to attain the desired orientation.

An object of the present invention is to provide a visual indication to the user as to how the level should be positioned in order to attain a desired orientation, without the user having to move the level itself.

In accordance with an embodiment of the present invention, a level that includes a frame, one or more vials mounted to the frame, and an illumination arrangement that selectively illuminates the one or more vials, is provided with a directional indication arrangement employing the illumination arrangement that is operable to inform a user as to how a first portion of the level should be positioned relative to a second portion of the level to achieve a desired orientation. Representatively, the illumination arrangement may be in the form of an LED arrangement.

The directional indication arrangement may include direction indicating indicia on the frame which, in conjunction with the illumination arrangement, informs the user as to how the level should be positioned to achieve the desired orientation. Representatively, the direction indicating indicia on the frame may be in the form of one or more arrows on the frame.

In one embodiment, the level includes a first vial mounted to the frame that is configured to gauge the orientation of the frame relative to level, a second vial mounted to the frame at a location spaced from the first vial in a first direction, and a third vial mounted to the frame at a location spaced from the first vial in a second direction opposite the first direction. The illumination arrangement is arranged to selectively illuminate at least the second and third vials, and the direction indicating indicia may be in the form of a first arrow on the frame in a location adjacent the second vial and a second arrow on the frame in a location adjacent the third vial.

Representatively, the illumination arrangement is operable to illuminate the second vial when the portion of the level in the vicinity of the first arrow should be moved in the direction of the first arrow to attain a desired orientation, and is operable to illuminate the third vial when the portion of the level in the vicinity of the second arrow should be moved in the direction of the second arrow to attain the desired orientation.

The illumination arrangement may function to operate in a flashing manner to indicate that the position of the portion of the level in the vicinity of one of the second and third vials should be altered in order to attain the desired orientation. The frequency of illumination of the illumination arrangement may be altered as the level approaches the desired orientation.

An audio indicator may operate in conjunction with the illumination arrangement, to provide both a visual signal and an audio signal to the user relating to the position of the level relative to the desired orientation. Representatively, the audio indicator may operate in an intermittent manner that is synchronous with the frequency of illumination of the illumination arrangement.

The present invention further contemplates a method of informing a user as to how a first portion of the level should be positioned relative to a second portion of the level to achieve a desired orientation, substantially in accordance with the foregoing summary.

Other aspects, features and advantages of the invention will become apparent to those skilled in the art from the following detailed description and accompanying drawings. It should be understood, however, that the detailed description and specific examples, while indicating certain embodiments of the present invention, are given by way of illustration and not of limitation. Many changes and modifications may be made within the scope of the present invention without departing from the spirit thereof, and the invention includes all such modifications.

### BRIEF DESCRIPTION OF THE DRAWINGS

A clear conception of the advantages and features constituting the present invention, and the construction and operation of typical mechanisms provided with the present invention, will become more readily apparent by referring to the exemplary, and therefore non-limiting, embodiments illustrated in the drawings accompanying and forming a part of this specification, wherein like reference numerals designate the same elements can be several views, and in which:

FIG. 1 is an elevation view of a level with a directional indication feature in accordance with an embodiment of the present invention;

FIG. 2 is an enlarged partial section view showing a level vial portion of the level with a directional indication feature as shown in FIG. 1;

FIG. 3 enlarged partial section view showing a plumb vial portion of the level with a directional indication feature as shown in FIG. 1;

FIG. 4 is an electronics block diagram for the level with a directional indication feature as shown in FIG. 1;

FIG. 5 is an enlarged partial plan view illustrating end portions of a level with a directional indication feature in accordance with an embodiment of the present invention;

FIG. 6 is a view showing use of the level with a directional indication feature of FIG. 1 in a sensing a level orientation; and

FIG. 7 is a view showing use of the level with a directional indication feature of FIG. 1 in a sensing a plumb orientation.

In describing the representative embodiment of the invention that is illustrated in the drawings, specific terminology will be resorted to for the sake of clarity. However, it is not intended that the invention be limited to the specific terms so selected, and it is to be understood that each specific term includes all technical equivalents, which operate in a similar manner to accomplish a similar purpose. For example, the words “connected,” “attached,” or terms similar thereto are often used. They are not limited to direct connection but include connection through other elements where such connection would be recognized as being equivalent by those skilled in the art.

### DETAILED DESCRIPTION

An embodiment of the present invention and the various features and advantageous details thereof are explained more fully with reference to the following description.

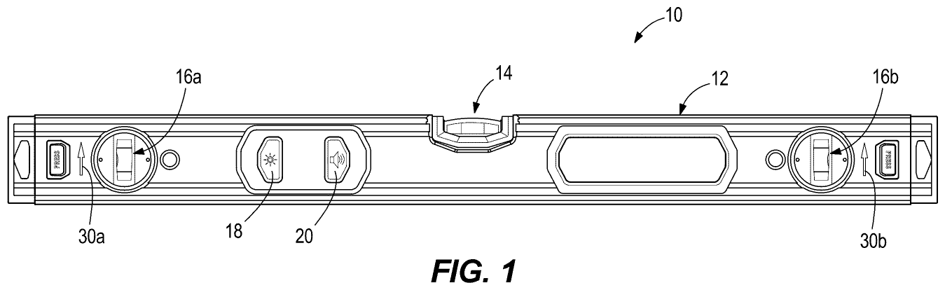

Referring to FIG. 1, a level 10 generally includes a frame 12 to which a number of bubble vials are mounted. In the illustrated embodiment, the frame 12 is of the type known as a box beam, and the vials mounted to the frame 12 consist of a level vial 14 and a pair of plumb vials 16a, 16b. It is understood, however, that the frame 14 may have any other type of construction, such as an I-beam or the like, and that any desired number and configuration of vials may be mounted to the frame in any desired orientation. In a manner as is known, the level vial 14 provides an indication of the orientation of a work surface relative to level when the frame 12 of level 10 placed on the work surface. The plumb vials 16a, 16b provide an indication of the orientation of the work surface relative to plumb or vertical when the frame 12 of level 10 is positioned against the work surface.

The level 10 may be employed in a conventional manner, in which the user observes the position of a bubble within the vials 14, 16a and 16b relative to the vial indicia to ascertain the orientation of a surface relative to level or plumb. However, in accordance with an embodiment of the present invention, the level 10 is also provided with both audio and visual indicator features. The visual indicator feature can be turned on and off using a visual indicator actuator switch 18 mounted to the frame 12, and the audio indicator feature can be turned on and off using an audio indicator actuator switch 20 mounted to the frame 12.

The visual indicator feature provides the dual function of illuminating the level vial 14 and the plumb vials 16a, 16b, and optionally providing an indication to the user as to how the level 10 should be positioned in order to attain either a level orientation or plumb orientation, as desired in a particular application.

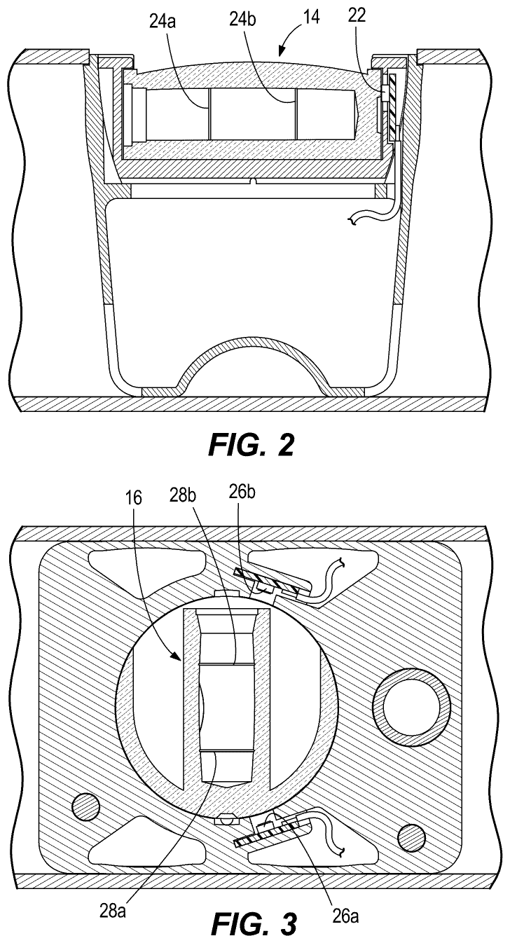

When the visual indicator feature is turned on using the visual indicator actuator switch 18, a series of LEDs are actuated in order to illuminate the level vial 14 and the plumb vials 16a, 16b. In the illustrated embodiment as shown in FIG. 2, the level vial 14 is illuminated by an LED 22, which is positioned adjacent the end of the level vial 14. Typically, the indicator marks 24a, 24b are in the form of rings positioned within the cylinder of the level vial 14, although the indicator marks 24a, 24b may be formed in any other manner as desired. As is known, the level vial 14 includes a bubble, the position of which relative to the indicator marks 24a, 24b provides a visual indication of level to the user. While the LED 22 is shown as being positioned in alignment with the indicator marks 24a, 24b, it is understood that the LED 22 may be positioned in any other desired orientation relative to the level vial 16 in order to illuminate the bubble.

As shown in FIG. 3, the plumb vials 16a, 16b are illuminated by a pair of LEDs 26a, 26b. The drawings illustrate plumb vial 16b and LEDs 26a, 26b, and it is understood that the arrangement of LEDs relative to plumb vial 16a is similar to that illustrated with respect to plumb vial 16b. The plumb vial 16b includes indicator marks 28a, 28b, which may be in the form of rings positioned within the cylinder of the plumb vial 16b, although the indicator marks 24a, 24b may be formed in any other manner as desired. In a manner as is known, the plumb vial 16b includes a bubble, the position of which relative to the indicator marks 28a, 28b provides a visual indication of plumb to the user. The LEDs 26a, 26b are oriented so as to illuminate the plumb vial 16b. In the illustrated embodiment, the LEDs 26a, 26b are shown as being oriented at an angle, such as at a 45 degree angle, relative to the longitudinal axis of the plumb vial 16b. It is understood, however, that the LEDs 26a, 26b may be positioned in any other desired orientation relative to the plumb vial 16b in order to illuminate the bubble relative to the indicator marks 28a, 28b.

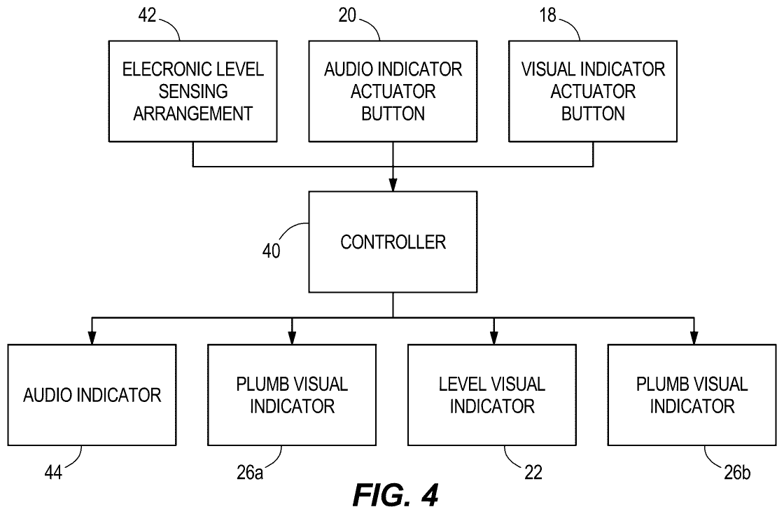

In the illustrated embodiment, the box beam construction of frame 12 provides an interior within which electronic components incorporated into the level 10 may be mounted. As shown in FIG. 4, the electronic components incorporated into the level 10 that are housed within the interior of the frame 12 include a controller 40 and an electronic level sensing arrangement 42 that provides signals to the controller 40. The visual indicator actuator switch 18 and audio indicator actuator switch 20 are also interconnected with the controller 40. The controller 40 provides outputs to an audio indicator output 44, such as a speaker, as well as to level vial LED 22 and plumb vial LEDs 26a, 26b. A suitable power supply, such as a batter, is interconnected in the circuit in a manner as is known in order to power the circuit components.

The electronic level sensing arrangement 42 detects the position of level 10 along its longitudinal axis relative to level (horizontal) and/or plumb (vertical). For example, the level sensing arrangement 42 generates a degree of level signal when the level 10 is oriented in the horizontal direction, which coincides with the bubble of level vial 14 being centered. The level sensing arrangement 42 also generates a signal representative of the position or orientation of level 10, which is input to the controller 40. In one embodiment, the level sensing arrangement 42 generates a degree of level or plumb signal when level 10 is within a certain range of level or plumb, such as within 1.14 degrees of level or plumb. The signal generated by level sensing arrangement 42 will be a level signal when the bubble of vial 14 is level and a plumb signal when the bubble of vial 16a or 16b is plumb and centered. In one embodiment, the level sensing arrangement 42 may be an accelerometer. In another embodiment, multiple level/plumb sensors may be for each different vial of level 10.

The controller 40 may be any electronic control device or circuit configured to control the various circuit components. Controller 40 receives the signal generated by level sensing arrangement 42 and interprets the signal to determine what if any control signal to generate and send to visual level vial LED 22 and/or plumb vial LEDs 26a, 26b.

In one mode of operation, the visual indicator actuator switch 18 may interact with the electronic controller so as to provide constant illumination of the LED's 22, 26a and 26b. This mode of operation simply provides a solid light output that illuminates the LED's so as to enhance their visibility.

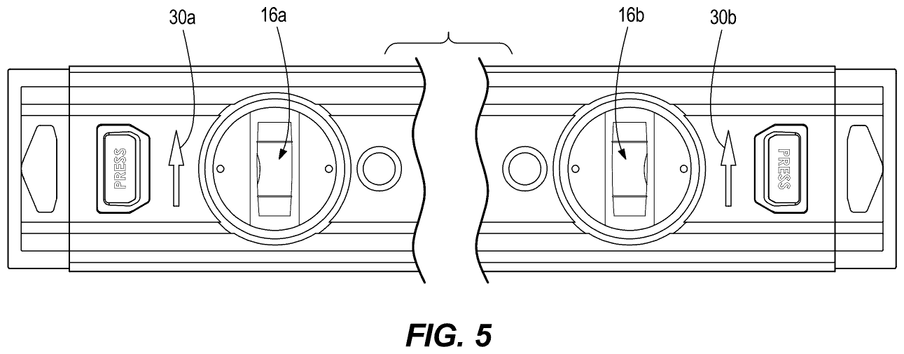

As shown in FIG. 5, the frame 12 of level 10 is provided with directional indicia adjacent the plumb vials 16a, 16b. In the illustrated embodiment, the directional indicia is in the form of an arrow 30a located adjacent plumb vial 16a, and an arrow 30b located adjacent plumb vial 16b. While the directional indicia is shown as being arrows, it is understood that any other suitable indicia may be employed.

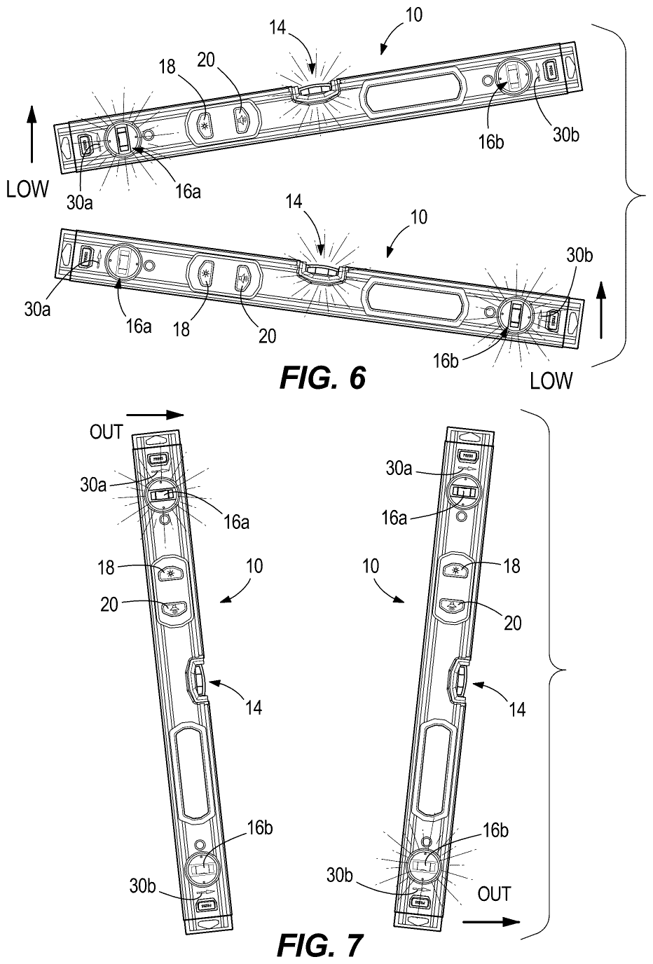

The arrows 30a, 30b and LEDs 22, 26a and 26b may cooperate to inform a user how the level 10 should be positioned to attain either a level orientation or a plumb orientation. As shown in FIG. 6, when the level 10 is placed on a work surface to gauge level, the level vial 14 is illuminated. When one end of the level is low relative to the other, which may be sensed by an accelerometer or other such electronic level sensing arrangement as noted above, controller functions to illuminate the plumb vial at the low end to indicate that that end of the level 10 should be raised. The arrow at the low end of the level 10 adjacent the illuminated LEDs indicates to the user the direction in which the level should be moved in order to achieve a level orientation. As shown in FIG. 6, when the level 10 is positioned such that the end bearing arrow 30a is low, the LEDs 26a illuminate the vial 16a. The arrow 30a shows the user that that end of the level 10 should be raised to attain level. Similarly, when the end bearing arrow 30b is low, the LEDs 26b illuminate the vial 16b. The arrow 30b shows the user that that end of the level 10 should be raised to attain level.

Illumination of the LEDs at the low end of the level 10 may be in the form of a flashing indicator, and the frequency of the flashing pulse rate may vary as the level orientation is approached. For example, the LEDs may flash slowly at first, then at a faster pace as the level approaches the level orientation, then may be illuminated solid when the level 10 is in a level orientation. Other variations may be employed, such as the reverse of that described or any other such pattern that provides a visual indication to the user.

Similarly, as shown in FIG. 7, when the level 10 is positioned to gauge plumb, which again may be sensed by an accelerometer or other plumb sensing arrangement as noted above, the plumb vial that should be moved in the direction of the arrow is illuminated to provide the user with a visual indicator as to how the level 10 should be positioned in order to achieve a plumb orientation. When the level 10 is positioned such that the end bearing arrow 30a should be moved in the direction of arrow 30a to attain plumb, the LEDs 26a illuminate the vial 16a. Similarly, when the end bearing arrow 30b should be moved in the direction of the arrow 30b to attain plumb, the LEDs 26b illuminate the vial 16b. Again, the pulsation rate of the LEDs may vary as the plumb orientation is approached.

As an alternative to the visual indication provided by the LEDs 22, 24a and 24b, the user may operate the visual indicator actuator switch 18 to switch off the visual indication feature and may switch the audio indicator switch 20 to the on position. When the audio indicator switch 20 is switched on, the accelerometer output signals are provided to an audio output device, such as a speaker. The audio output may be intermittent, such that the frequency of the audio output rate may vary as the level or plumb orientation is approached. For example, the audio output may intermittently beep slowly at first, then at a faster pace as the level approaches the level or plumb orientation, then may be an uninterrupted sound when the level 10 is in the level or plumb orientation. Alternatively, the tone of the audio output may vary to alert the user as to the position of the level 10 relative to the desired orientation. Other variations may be employed, such as the reverse of that described or any other such pattern that provides an audio indication to the user.

The visual indication of the orientation of the level 10 provided by the flashing LEDs may also be coordinated with the audio indicator, when both the visual indicator switch 18 and the audio indicator switch 20 are in the on position. Representatively, the frequency of the pulsed LED outputs may be synchronized with the frequency of the pulsed audio outputs, to provide the user with both visual and audio feedback as to when the level 10 is approaching either a level orientation or a plumb orientation.

The visual indicator switch 18 may have both a digital position in which it is used as a means of providing a visual alert to the user as to the position of the level, and a solid on position in which the sole function of the LED's is to illuminate the level vials to enhance visibility.

When the visual indicator switch 18 is in the digital on position, the controller is operable to provide the visual directional indication feature when the level 10 is positioned within a certain predetermined range on either side of true level or true plumb. The controller does not illuminate the LED's when the level 10 is positioned outside the predetermined range. The same holds true for when the audio indicator switch 20 is in the digital position, in that the audio indication feature is only operable when the level 10 is positioned within a certain predetermined range on either side of true level or true plumb, and is not operable when the level 10 is positioned outside the predetermined range.

The chart below outlines the operation of the LEDs in various conditions relative to level and plumb, and contains a representative illustration as to coordination of the audio and visual signals that are output as the level approaches the level and plumb orientations.

| Audio | LED | | | Left/Top | | Right/Bottom | |
|---|---|---|---|---|---|---|---|
| Button | Button | Level | Level State | Plumb | Center | Plumb | |
| State | State | Orientation | (+Clockwise) | LED State | LED State | LED State | Audio State |
| OFF | OFF | N/A | N/A | — | — | — | — |
| | Digital | Level | 1.14° ≥ [symbol] > 0° (2% ≥ x > 0%) | — | 2BPS to 4BPS | 2BPS to 4BPS | — |

| | | | | | | |
|---|---|---|---|---|---|---|
| Orientation | 0° | (0%) | — | Solid Light | — | — |

| 0° ≥ x > −1.14° (0% ≥ x > −2%) | | 2BPS to 4BPS | 2BPS to 4BPS | — | — |
|---|---|---|---|---|---|
| >±1.14° | (>±2%) | — | 1BPS | — | — |

| | | | | | | | |
|---|---|---|---|---|---|---|---|
| | | Plumb | 91.14° ≥ x > 90° | — | — | 2BPS to 4BPS | — |
| | | Orientation | 90° | Solid Light | — | Solid Light | — |
| | | | 90° ≥ x > 8 [symbol] .86° | 2BPS to 4BPS | — | — | — |
| | | | >91.14 & <8 [symbol] .86 | 1BPS | — | 1BPS | — |
| | ON | N/A | N/A | Solid Light | Solid Light | Solid Light | — |
| Digital | OFF | Level | 1.14° ≥ [symbol] > 0° (2% ≥ x > 0%) | — | — | — | 2BPS to 4BPS, Low Tone |

| | | | | | | |
|---|---|---|---|---|---|---|
| Orientation | 0° | (0%) | — | — | — | Solid Tone |

| 0° ≥ x > −1.14° (0% ≥ x > −2%) | | — | — | — | 2BPS to 4BPS, High Tone |
|---|---|---|---|---|---|
| >±1.14° | (>±2%) | — | — | — | 1BPS |

| | | | | | | |
|---|---|---|---|---|---|---|
| | Plumb | 91.14° ≥ x > 90° | — | — | — | 2BPS to 4BPS, Low Tone |
| | Orientation | 90° | — | — | — | Solid Tone |
| | | 90° ≥ x > 8 [symbol] .86° | — | — | — | 2BPS to 4BPS, High Tone |
| | | >91.14 & <8 [symbol] .86 | — | — | — | 1BPS |
| Digital | Level | 1.14° ≥ [symbol] > 0° (2% ≥ x > 0%) | — | 2BPS to 4BPS | 2BPS to 4BPS | 2BPS to 4BPS, Low Tone |

| | | | | | | |
|---|---|---|---|---|---|---|
| Orientation | 0° | (0%) | — | Solid Light | — | Solid Tone |

| 0° ≥ [symbol] > −1.14° (0% ≥ x > −2%) | | 2BPS to 4BPS | 2BPS to 4BPS | — | 2BPS to 4BPS, High Tone |
|---|---|---|---|---|---|
| >±1.14° | (>±2%) | — | 1BPS | — | 1BPS |

| | | | | | | |
|---|---|---|---|---|---|---|
| | Plumb | 91.14° ≥ x > 90° | — | — | 2BPS to 4BPS | 2BPS to 4BPS, Low Tone |
| | Orientation | 90° | Solid Light | — | Solid Light | Solid Tone |
| | | 90° ≥ x > 8 [symbol] .86° | 2BPS to 4BPS | — | — | 2BPS to 4BPS, High Tone |
| | | >91.14 & <8 [symbol] .86 | 1BPS | — | 1BPS | 1BPS |
| ON | Level | 1.14° ≥ x [symbol] 0° (2% ≥ x > [symbol] %) | Solid Light | Solid Light | Solid Light | 2BPS to 4BPS, Low Tone |

| | | | | | | |
|---|---|---|---|---|---|---|
| Orientation | 0° | (0%) | Solid Light | Solid Light | Solid Light | Solid Tone |

| 0° ≥ x > −1.14° (0% ≥ x > −2%) | | Solid Light | Solid Light | Solid Light | 2BPS to 4BPS, High Tone |
|---|---|---|---|---|---|
| >±1.14° | (>±2%) | Solid Light | Solid Light | Solid Light | 1BPS |

| | | | | | |
|---|---|---|---|---|---|
| Plumb | 91.14° ≥ x > 90° | Solid Light | Solid Light | Solid Light | 2BPS to 4BPS, Low Tone |
| Orientation | 90° | Solid Light | Solid Light | Solid Light | Solid Tone |
| | 90° ≥ x [symbol] 8 [symbol] .86° | Solid Light | Solid Light | Solid Light | 2BPS to 4BPS, High Tone |
| | >91.14 & <8 [symbol] .86 | Solid Light | Solid Light | Solid Light | 1BPS |

[symbol]

indicates data missing or illegible when filed

Although the best mode contemplated by the inventor of carrying out the present invention is disclosed above, practice of the present invention is not limited thereto. It will be manifest that various additions, modifications and rearrangements of the aspects and features of the present invention may be made in addition to those described above without deviating from the spirit and scope of the underlying inventive concept. The scope of some of these changes is discussed above. The scope of other changes to the described embodiments that fall within the present invention but that are not specifically discussed above will become apparent from the appended claims and other attachments. It is also understood that the invention disclosed and defined herein extends to all alternative combinations of two or more of the individual features mentioned or evident from the text and/or drawings. All of these different combinations constitute various alternative aspects of the present invention.

I claim:

1. A level, comprising a frame, one or more vials mounted to the frame, an illumination arrangement that selectively illuminates the one or more vials, and a directional indication arrangement employing the illumination arrangement, wherein the directional indication arrangement is operable to inform a user as to how a first portion of the level should be positioned relative to a second portion of the level to achieve a desired orientation.

2. The level of claim 1, wherein the illumination arrangement comprises an LED arrangement.

3. The level of claim 1, further comprising direction indicating indicia on the frame, wherein the direction indicating indicia in conjunction with the illumination arrangement informs the user as to how the level should be positioned to achieve the desired orientation.

4. The level of claim 3, wherein the direction indicating indicia on the frame comprises one or more arrows on the frame.

5. The level of claim 2, wherein the level includes a first vial mounted to the frame that is configured to gauge the orientation of the frame relative to level, a second vial mounted to the frame at a location spaced from the first vial in a first direction, and a third vial mounted to the frame at a location spaced from the first vial in a second direction opposite the first direction, wherein the illumination arrangement is arranged to selectively illuminate the second and third vials, and wherein the direction indicating indicia comprises a first arrow on the frame in a location adjacent the second vial and a second arrow on the frame in a location adjacent the third vial.

6. The level of claim 5, wherein the illumination arrangement is operable to illuminate the second vial when the portion of the level in the vicinity of the first arrow should be moved in the direction of the first arrow to attain a desired orientation, and is operable to illuminate the third vial when the portion of the level in the vicinity of the second arrow should be moved in the direction of the second arrow to attain the desired orientation.

7. The level of claim 6, wherein the illumination arrangement functions to operate in a flashing manner to indicate that the position of the portion of the level in the vicinity of one of the second and third vials should be altered in order to attain the desired orientation.

8. The level of claim 7, wherein the illumination arrangement functions to alter a frequency of illumination of the illumination arrangement as the level approaches the desired orientation.

9. The level of claim 7, further comprising an audio indicator that operates in conjunction with the illumination arrangement, wherein the illumination arrangement and the audio indicator provide both a visual signal and an audio signal to the user relating to the position of the level relative to the desired orientation.

10. The level of claim 9, wherein the audio indicator operates in an intermittent manner that is synchronous with the frequency of illumination of the illumination arrangement.

11. A method of positioning a level, wherein the level comprises a frame, two or more vials mounted to the frame, and an illumination arrangement, comprising selectively illuminating certain of the two or more vials using the illumination arrangement to inform a user as to how a first portion of the level should be positioned relative to a second portion of the level to achieve a desired orientation.

12. The method of claim 11, wherein the illumination arrangement comprises an LED arrangement.

13. The method of claim 11, wherein the level includes direction indicating indicia on the frame, wherein the direction indicating indicia in conjunction with the illumination arrangement informs the user as to how the level should be positioned to achieve the desired orientation.

14. The method of claim 13, wherein the direction indicating indicia on the frame comprises one or more arrows on the frame.

15. The method of claim 12, wherein the level includes a first vial mounted to the frame that is configured to gauge the orientation of the frame relative to level, a second vial mounted to the frame at a location spaced from the first vial in a first direction, and a third vial mounted to the frame at a location spaced from the first vial in a second direction opposite the first direction, wherein the illumination arrangement selectively illuminates the second and third vials, and wherein the direction indicating indicia comprises a first arrow on the frame in a location adjacent the second vial and a second arrow on the frame in a location adjacent the third vial.

16. The method of claim 15, comprising operating the illumination arrangement to illuminate the second vial when the portion of the level in the vicinity of the first arrow should be moved in the direction of the first arrow to attain a desired orientation, and operating the illumination arrangement to illuminate the third vial when the portion of the level in the vicinity of the second arrow should be moved in the direction of the second arrow to attain the desired orientation.

17. The method of claim 16, comprising operating the illumination arrangement functions in a flashing manner to indicate that the position of the portion of the level in the vicinity of one of the second and third vials should be altered in order to attain the desired orientation.

18. The method of claim 17, comprising altering a frequency of illumination of the illumination arrangement as the level approaches the desired orientation.

19. The level of claim 17, further comprising operating an audio indicator in conjunction with the illumination arrangement, wherein the illumination arrangement and the audio indicator provide both a visual signal and an audio signal to the user relating to the position of the level relative to the desired orientation.

20. The level of claim 19, comprising operating the audio indicator in an intermittent manner that is synchronous with the frequency of illumination of the illumination arrangement.
